(19) United States
(12) Patent Application Publication
(10) Pub. No.: US 2007/0297576 A1
(43) Pub. Date: Dec. 27, 2007

(54) METHOD AND DEVICE FOR CONTROLLING CHANNEL STATE INFORMATION TRANSFERRED BY A FIRST TELECOMMUNICATION DEVICE TO A SECOND TELECOMMUNICATION DEVICE

(75) Inventor: Yoshitaka Hara, Rennes Cedex (FR)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Tokyo (JP)

(21) Appl. No.: 11/767,201

(22) Filed: Jun. 22, 2007

(30) Foreign Application Priority Data
Jun. 23, 2006 (EP) 06 291044.3

(51) Int. Cl. H04M 1/24; H04M 3/08; H04M 3/22

(52) U.S. Cl. 379/1.01

(57) ABSTRACT

The present invention concerns a method for controlling channel state information transferred by a first telecommunication device to a second telecommunication device, the first telecommunication device determining information representative of the quality of the signals transferred between the first and second telecommunication devices. The method comprises the steps executed by the second telecommunication device of: determining a number of information representative of the quality of the signals transferred between the first and second telecommunication devices the first telecommunication device has to report as a channel state information, transferring the determined number to the first telecommunication device.

The present invention relates generally to telecommunication systems and in particular, to methods and devices for controlling channel state information transferred by a first telecommunication device to a second telecommunication device.

Recently, efficient transmission schemes in space and frequency domains have been investigated to meet the growing demand for high data rate wireless telecommunications. In the space domain, Multi-input Multi-Output (MIMO) systems using multiple antennas at both transmitter and receiver sides have gained attention to exploit the potential increase of the spectral efficiency.

In some transmission schemes using MIMO systems, the telecommunication device which transmits data streams has some knowledge of the channel conditions which exist between itself and the telecommunication devices to which the data streams are transferred. The telecommunication device directs the signals transferred to a telecommunication device according to the channel conditions, and then improves the overall performances of the system.

Practically, when the channels responses between uplink and downlink channels are reciprocal, e.g. in Time Division Multiplex systems, the channel conditions are obtained according to the following method: a telecommunication device like a base station transfers pilot signals to another telecommunication device like a mobile terminal, the mobile terminal receives the pilot signals, determines the channel responses from the received pilot signals, as example under the form of a channel matrix which is representative of the channel conditions, and uses the determined matrix in order to direct the signals which have to be transferred to the base station which has sent the pilot signals.

The coefficients of the determined channel matrix are the complex propagation gains between the antennas of the base station and the antennas of the mobile terminal.

Some of the complex propagation gains reflect poor channel propagation conditions which exist between some antennas of the base station and the mobile terminal.

If an important number of mobile terminals report all coefficients of the determined channel matrix to the base station, the transfer of these coefficients requires an important part of the available bandwidth of the overall wireless telecommunication network and the base station needs to have important calculation means in order to treat all these coefficient.

Other channel conditions measurements can also be determined. The channel conditions are as example the Signal to Interference plus Noise Ratio measured by the mobile terminal.

If an important number of mobile terminals report all the Signal to Interference plus Noise Ratio, the transfer of these data requires an important part of the available bandwidth of the overall wireless telecommunication network and the base station needs to have important calculation means in order to treat all these coefficient.

The aim of the present invention is to propose methods and devices which enable the reporting of the channel conditions without requiring an important part of the available bandwidth of the overall wireless telecommunication network.

To that end, the present invention concerns a method for controlling channel state information transferred by a first telecommunication device to a second telecommunication device, the first telecommunication device determining information representative of the quality of the signals transferred between the first and second telecommunication devices, characterised in that the method comprises the steps executed by the second telecommunication device of:

determining a number of information representative of the quality of the signals transferred between the first and second telecommunication devices the first telecommunication device has to report as a channel state information,

transferring the determined number to the first telecommunication device.

The present invention concerns also a device for controlling channel state information transferred by a first telecommunication device to a second telecommunication device, the first telecommunication device determining information representative of the quality of the signals transferred between the first and second telecommunication devices, characterised in that the device for controlling is included in the second telecommunication device and comprises:

means for determining a number of information representative of the quality of the signals transferred between the first and second telecommunication devices the first telecommunication device has to report as a channel state information,

means for transferring the determined number to the first telecommunication device.

Thus, the second telecommunication device is able to control the quantity of information representative of the quality of the signals transferred between the first and second telecommunication devices.

According to a particular feature, the number of information representative of the quality of the signals transferred between the first and second telecommunication devices the first telecommunication device has to report is lower than the number of the determined information representative of the quality of the signals transferred between the first and second telecommunication devices.

Thus, the part of the available bandwidth of the overall wireless telecommunication network used for the receiving the channel state information is reduced.

According to a particular feature, the second telecommunication device allocates to the first telecommunication device a number of pilot signals which is equal to the determined number.

Thus, the available pilot signals are used efficiently.

According to a particular feature, the second telecommunication device receives the channel state information from the first telecommunication device and controls the transfer of the signals representative of at least a group of data between the first and the second telecommunication devices according to received the channel state information.

Thus, it is possible to allocate the resources of the network in an efficient way.

According to a particular feature, the second telecommunication device determines the number of first telecommunication devices which are linked to the second telecommunication device.

A first telecommunication device is linked to the second telecommunication device when it can transfer signals to the second telecommunication device and receive signals from the second telecommunication device.

According to a particular feature, the number of information representative of the quality of the signals transferred between the first and second telecommunication devices the first telecommunication device has to report as a channel state information is determined according to the number of first telecommunication devices which are linked to the second telecommunication device.

Thus, the second telecommunication device allocates the resources of the network among the first telecommunication fairly.

According to a particular feature, the second telecommunication device receives the number of antennas each first telecommunication device comprises and determines the number of information representative of the quality of the signals transferred between the first and second telecommunication devices each first telecommunication device has to report as a channel state information according to the number of antennas the first telecommunication device comprises.

Thus, the second telecommunication device allocates the resources of the network among the first telecommunication according to their communication capabilities.

According to a particular feature, the second telecommunication device receives from each first telecommunication device their respective requirement in term of data rate and determines the number of information representative of the quality of the signals transferred between the first and second telecommunication devices each first telecommunication device has to report as a channel state information according to the requirements in term of data rate.

Thus, the second telecommunication device allocates the resources of the network among the first telecommunication according to their communication needs.

According to a particular feature, the second telecommunication device receives from each first telecommunication device, their respective requirement in term of response delay and the number of information representative of the quality of the signals transferred between the first and second telecommunication devices each first telecommunication device has to report as a channel state information is determined according to the requirements in term of response delay.

Thus, the second telecommunication device allocates the resources of the network among the first telecommunication according to their communication needs.

According to still another aspect, the present invention concerns a method for transferring, by a first telecommunication device, channel state information to a second telecommunication device, the first telecommunication device determining information representative of the quality of the signals transferred between the first and second telecommunication devices, characterised in that the method comprises the steps executed by the first telecommunication device of:

receiving from the second telecommunication device a number of information representative of the quality of the signals transferred between the first and second telecommunication devices the first telecommunication device has to report as a channel state information,

determining a channel state information which comprises the received number of information representative of the quality of the signals transferred between the first and second telecommunication devices,

transferring the channel state information to the second telecommunication device.

The present invention concerns also a first telecommunication device which transfers channel state information to a second telecommunication device, the first telecommunication device determining information representative of the quality of the signals transferred between the first and second telecommunication devices, characterised in that the first telecommunication device comprises:

means for receiving from the second telecommunication device a number of information representative of the quality of the signals transferred between the first and second telecommunication devices the first telecommunication device has to report as a channel state information,

means for determining a channel state information which comprises the received number of information representative of the quality of the signals transferred between the first and second telecommunication devices,

means for transferring the channel state information to the second telecommunication device.

Thus, the quantity of information representative of the quality of the signals transferred between the first and second telecommunication devices is reduced.

According to a particular feature, the first telecommunication device comprises antennas and the second telecommunication device which comprises antennas and in that the quality of the signals transferred between the first and second telecommunication devices is the propagation gain between one antenna of the first telecommunication devices and one antenna of the second telecommunication device.

Thus, the second telecommunication device is informed about the propagation gains which are determined by the first telecommunication device.

According to a particular feature, the propagations gains are coefficients of a downlink channel matrix and the measured information representative of the quality of the signals transferred between the first and second telecommunication devices comprised in the channel state information are determined by executing a singular value decomposition of the downlink channel matrix.

Thus, the second telecommunication device is informed about the propagation gains which are determined by the first telecommunication device in the downlink channel.

According to a particular feature, the propagations gains are coefficients of an uplink channel matrix and the determined information representative of the quality of the signals transferred between the first and second telecommunication devices comprised in the channel state information are determined by executing a singular value decomposition of the uplink channel matrix.

Thus, the second telecommunication device is informed about the propagation gains which are determined by the first telecommunication device in the uplink channel.

According to still another aspect, the present invention concerns computer programs which can be directly loadable into a programmable device, comprising instructions or portions of code for implementing the steps of the methods according to the invention, when said computer programs are executed on a programmable device.

Since the features and advantages relating to the computer programs are the same as those set out above related to the methods and devices according to the invention, they will not be repeated here.

According to still another aspect, the present invention concerns a signal transferred to a second telecommunication device from a first telecommunication device, characterised in that the signal comprises a number of information representative of the quality of the signals transferred between the first and second telecommunication devices the first telecommunication device has to report as a channel state information to the second telecommunication device.

Since the features and advantages relating to the signal arc the same as those set out above related to the methods and devices according to the invention, they will not be repeated here.

The characteristics of the invention will emerge more clearly from a reading of the following description of an example embodiment, the said description being produced with reference to the accompanying drawings, among which:

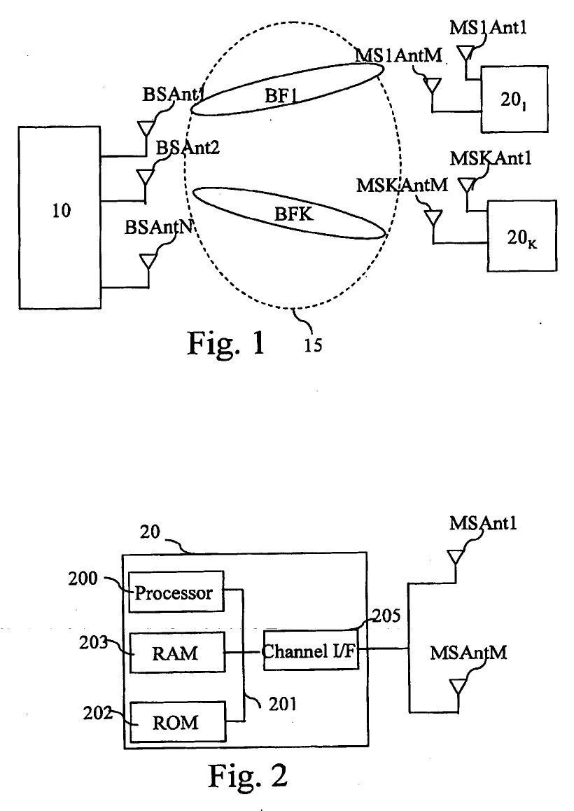

FIG. 1 is a diagram representing the architecture of the wireless network according to the present invention;

FIG. 2 is a diagram representing the architecture of a first telecommunication device according to the present invention;

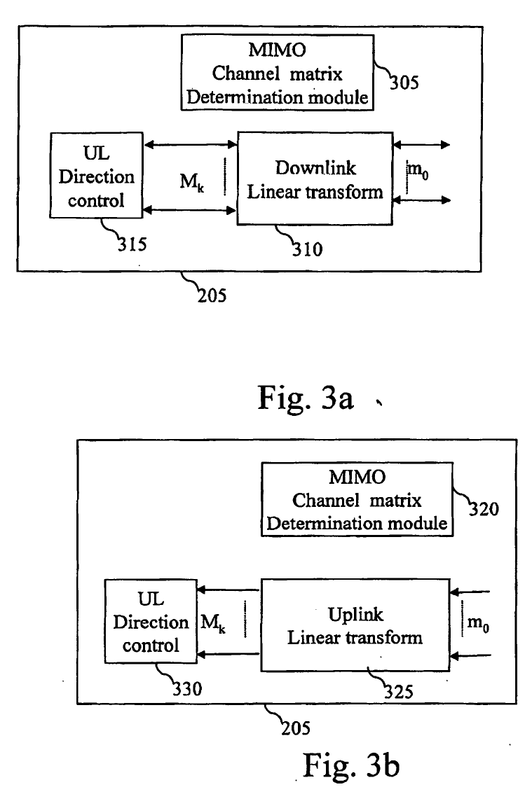

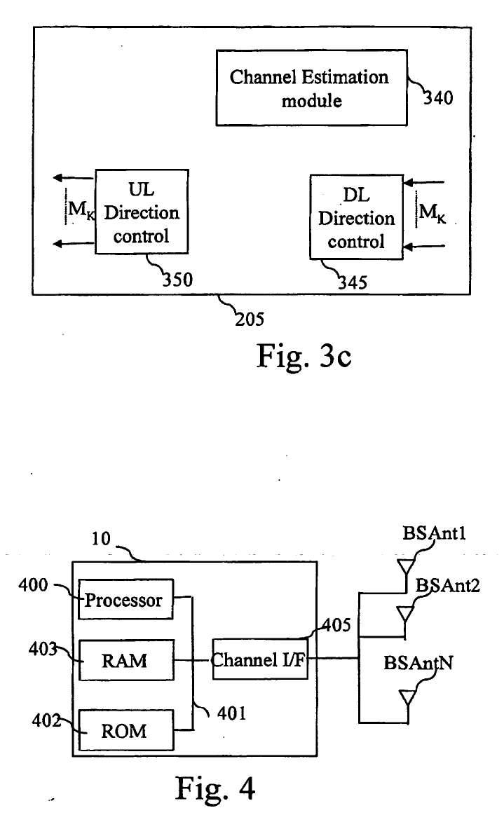

FIG. 3a is a diagram representing the architecture of a channel interface according to a first mode of realisation of the first telecommunication device;

FIG. 3b is a diagram representing the architecture of a channel interface according to a second mode of realisation of the first telecommunication device;

FIG. 3c is a diagram representing the architecture of a channel interface according to a third mode of realisation of the first telecommunication device;

FIG. 4 is a diagram representing the architecture of the second telecommunication device according to the present invention;

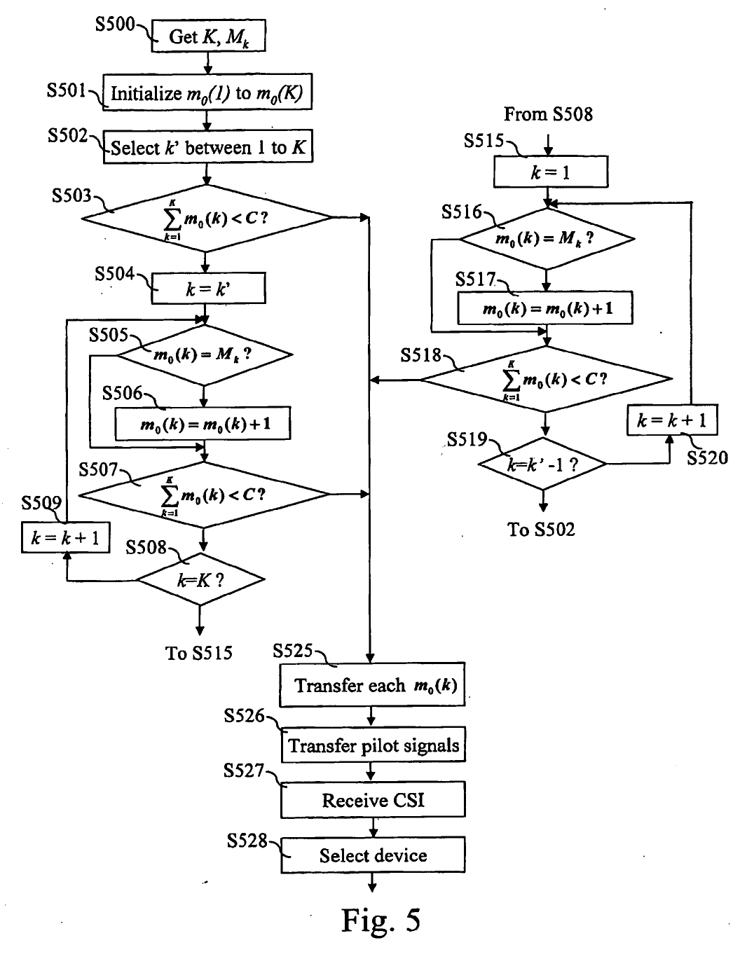

FIG. 5 is an algorithm executed by the second telecommunication device according to a first mode of realisation of the second telecommunication device;

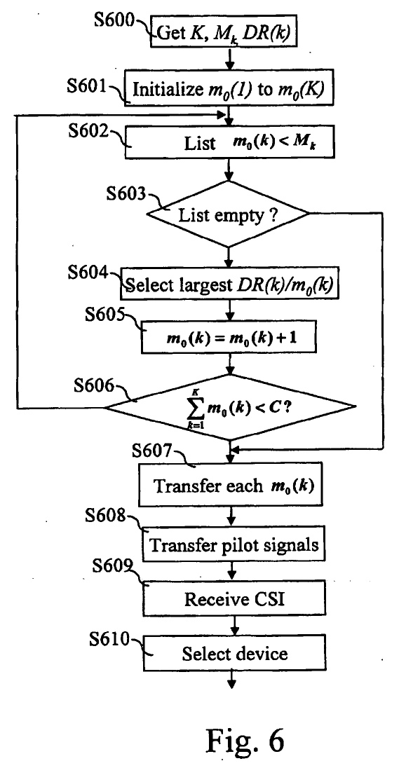

FIG. 6 is an algorithm executed by the second telecommunication device according to a second mode of realisation of the second telecommunication device;

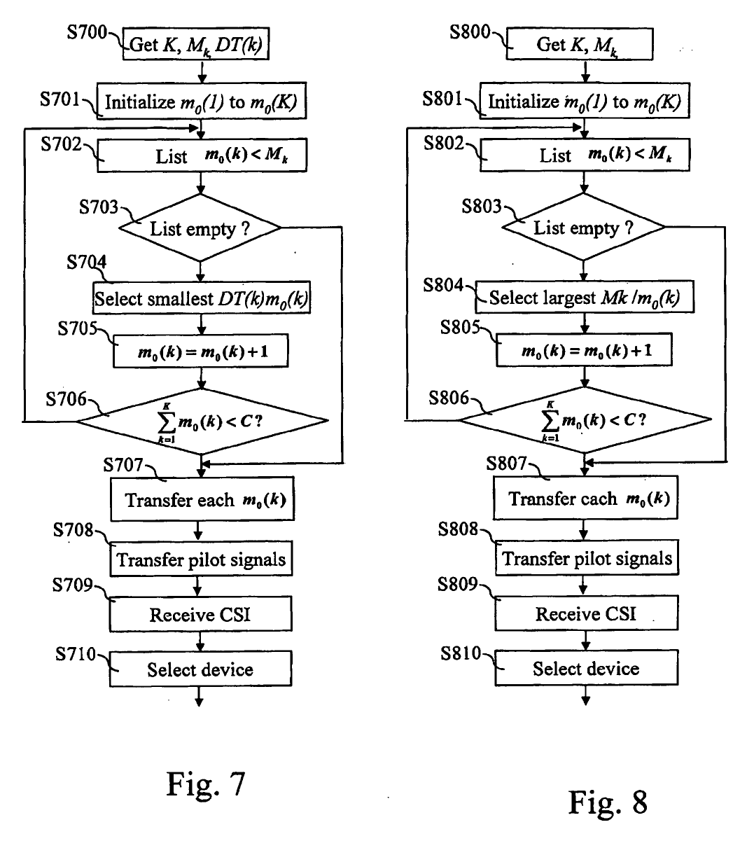

FIG. 7 is an algorithm executed by the second telecommunication device according to a third mode of realisation of the second telecommunication device;

FIG. 8 is an algorithm executed by the second telecommunication device according to a fourth mode of realisation of the second telecommunication device;

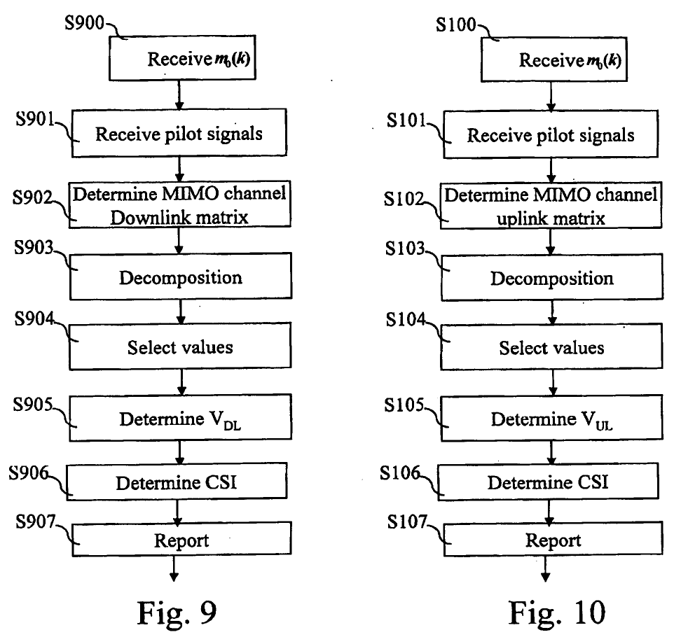

FIG. 9 is an algorithm executed by the first telecommunication device according to the first mode of realisation of the first telecommunication device;

FIG. 10 is an algorithm executed by the first telecommunication device according to the second mode of realisation of the first telecommunication device;

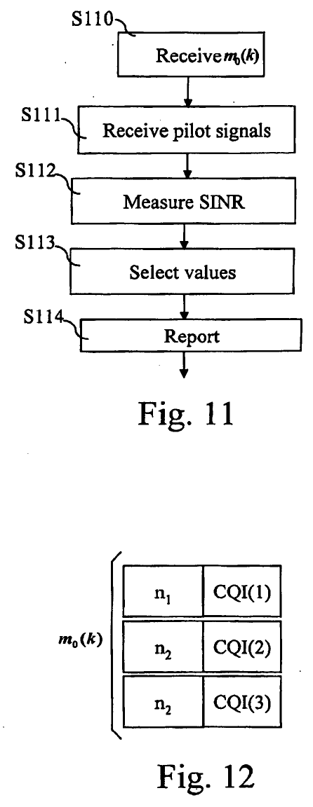

FIG. 11 is an algorithm executed by the first telecommunication device according to the third mode of realisation of the first telecommunication device;

FIG. 12 is an example of the channel state information transferred by a first telecommunication device according to the third mode of realisation of the first telecommunication device.

FIG. 1 is a diagram representing the architecture of the wireless network according to present invention.

In the wireless network of the FIG. 1, at least one and preferably plural first telecommunication devices 20₁ or 20_{K} are linked through a wireless network 15 to a second telecommunication device 10 using an uplink and a downlink channel.

Preferably, and in a non limitative way, the second telecommunication device 10 is a base station or a node of the wireless network 15. The first telecommunication devices 20₁ to 20_{K} are terminals like mobile phones, personal digital assistants, or personal computers.

The telecommunication network 15 is a wireless telecommunication system which uses Time Division Duplexing scheme (TDD) or Frequency Division Duplexing scheme (FDD).

In TDD scheme, the signals transferred in uplink and downlink channels are duplexed in different time periods in the same frequency band. The signals transferred within the wireless network 15 share the same frequency spectrum. The channel responses between the uplink and downlink channels of the telecommunication network 15 are reciprocal.

Reciprocal means that if the downlink channel conditions are represented by a downlink matrix, the uplink channel conditions can be expressed by an uplink matrix which is the transpose of the downlink matrix.

In FDD scheme, the signals transferred in uplink and downlink channels are duplexed in different frequency bands. The spectrum is divided into different frequency bands and the uplink and downlink signals are transmitted simultaneously. The channel responses between the uplink and downlink channels of the telecommunication network 15 are not perfectly reciprocal.

The second telecommunication device 10 transfers simultaneously signals representatives of at most N groups of data or pilot signals to the first telecommunication devices 20₁ to 20_{K} through the downlink channel and the first telecommunication devices 20₁ to 20_{K} transfer signals to the second telecommunication device 10 through the uplink channel.

The signals transferred by the first telecommunication devices 20₁ to 20_{K} are signals representatives of a group of data or pilot signals.

A group of data is as example a frame constituted at least by a header field and a payload field which comprises classical data like data related to a phone call, or a video transfer and so on.

Pilot signals are predetermined sequences of symbols known by the telecommunication devices. Pilot signals are, as example and in a non limitative way, Walsh Hadamard sequences.

According to the first mode of realisation of the first telecommunication device 20, the pilot signals transferred by the first telecommunication devices 20₁ to 20_{K} are multiplied by a downlink linear transform. The transferred pilot signals comprise then channel state information.

According to the second mode of realisation of the first telecommunication device 20, the pilot signals transferred by the first telecommunication devices 20, to 20_{K} are multiplied by an uplink linear transform. The transferred pilot signals comprise then channel state information.

According to the third mode of realisation of the first telecommunication device 20, the channel state information is transferred into the form of bit information.

The second telecommunication device 10 has N antennas noted BSAnt1 to BSAntN. The second telecommunication device 10 preferably controls the spatial direction of the signals transferred to each first telecommunication devices 20₁ to 20_{K} according to the channel state information transferred by each first telecommunication devices 20 as it will be disclosed hereinafter.

More precisely, when the second telecommunication device 10 transmits signals representatives of a group of data to a given first telecommunication device 20ₖ through the downlink channel, the signals are at most N times duplicated in order to perform beamforming, i.e. controls the spatial direction of the transmitted signals.

The ellipse noted BF1 in the FIG. 1 shows the pattern of the radiated signals by the antennas BSAnt1 to BSAntN which are transferred to the first telecommunication device 20₁ by the second telecommunication device 10.

The ellipse noted BFK in the FIG. 1 shows the pattern of the radiated signals by the antennas BSAnt1 to BSAntN which are transferred to the first telecommunication device 20_{K} by the second telecommunication device 10.

The first telecommunication devices 20₁ to 20_{K} have Mₖ antennas noted respectively MS1Ant1 to MS1AntM₁ and MSKAnt1 to MSKAntMₖ. It has to be noted here that the number Mₖ of antennas may vary according to each first telecommunication device 20ₖ with k=1 to K. Each first telecommunication device 20₁ to 20ₖ controls the spatial direction of the signals transferred to the second telecommunication device 10 as it will be disclosed hereinafter.

Each first telecommunication device 20₁ to 20ₖ controls the spatial direction of the signals transferred to the second telecommunication device 10 by Mₖ times duplicating the signals and weighting the duplicated signals by coefficients in order to perform beamforming, i.e. controls the spatial direction of the transmitted signals.

The ellipse noted BF1 in the FIG. 1 shows the pattern of the radiated signals by the antennas MS1Ant1 to MS1AntM₁ which are transferred by the first telecommunication device 20₁ to the second telecommunication device 10.

The ellipse noted BFK in the FIG. 1 shows the pattern of the radiated signals by the antennas MSKAnt1 to MSKAntM_{K} which are transferred by the first telecommunication device 20_{K} to the second telecommunication device 10.

According to the third mode of realisation of the first telecommunication device 20, each first telecommunication device 20₁ to 20ₖ controls the spatial direction of the signals received from the second telecommunication device 10 in order to perform beamforming, i.e. controls the spatial direction of the received signals.

The second telecommunication device 10 determines, for each first telecommunication device 20_{k,} the number of information representative of the quality of the signal transferred between the first and second telecommunication device each first telecommunication device 20ₖ has to report as a the channel state information between.

Each first telecommunication device 20ₖ receives from the second telecommunication device 10 a number of information representative of the quality of the signals transferred between the first and second telecommunication devices the first telecommunication device has to report as a channel state information.

FIG. 2 is a diagram representing the architecture of a first telecommunication device according to the present invention.

The first telecommunication device 20, as example the first telecommunication device 20ₖ, with k comprised between 1 and K, has, for example, an architecture based on components connected together by a bus 201 and a processor 200 controlled by programs related to the algorithm as disclosed in the FIGS. 9 or 10 or 11.

It has to be noted here that the first telecommunication device 20 is, in a variant, implemented under the form of one or several dedicated integrated circuits which execute the same operations as the one executed by the processor 200 as disclosed hereinafter.

The bus 201 links the processor 200 to a read only memory ROM 202, a random access memory RAM 203 and a channel interface 205.

The read only memory ROM 202 contains instructions of the programs related to the algorithm as disclosed in the FIGS. 9 or 10 or 11 which are transferred, when the first telecommunication device 20ₖ is powered on to the random access memory RAM 203.

The RAM memory 203 contains registers intended to receive variables, and the instructions of the programs related to the algorithm as disclosed in the FIGS. 9 or 10 or 11.

The channel interface 205 enables the transfer and/or of the reception of signals to and/or from the second telecommunication device 10.

The channel interface 205 will be described in detail in reference to the FIG. 3a, FIG. 3b and FIG. 3c.

FIG. 3a is a diagram representing the architecture of a channel interface according to a first mode of realisation of the first telecommunication device.

According to the first mode of realisation of the first telecommunication device, the channel interface 205 comprises a MIMO channel matrix estimation module 305.

The MEMO channel matrix estimation module 305 receives the Mₖ*1 signals xₖ(p)=H_{DL,k}s(p)+zₖ(p), where, s(p)=[s₁(p), . . . , s_{N}(p)]^{T} are signals representative of the p-th pilot symbol transferred by the second telecommunication device 10, zₖ(p) is the Mₖ*1 interference plus noise vector at the first telecommunication device 20ₖ and H_{DL,k} is the Mₖ*N downlink MIMO channel matrix between the second telecommunication device 10 and first telecommunication device 20ₖ.

The MIMO channel matrix estimation module 305 estimates the matrix H_{DL,k}.

Each element (m,n) with m=1 to Mₖ and n=1 to N of the matrix H_{DL,k} represents the complex propagation gain from the n-th antenna of the second telecommunication device 10 and the m-th of the first telecommunication device 20ₖ.

The channel interface 205 comprises a downlink linear transform module 310 which comprises means for executing a linear transformation of the signal vector xₖ(p) using a m₀*Mₖ matrix V_{DL}^{T}.

Then, the linear transform yields the m₀*1 output vector:
x′(p)=V_{DL}^{T}x(p)
x′(p)=V_{DL}^{T}H_{DL,k}s(p)+zₖ(p)′ where V_{DL}^{T}=└v_{DL,1}, . . . , v_{DL,m}_{₀}┘ and zₖ(p)′=V_{DL}^{T}zₖ(p)

The dimension of the downlink linear transform matrix V_{DL}^{T} is defined according to the number of information representative of the quality of the signals transferred between the first and second telecommunication devices that the first telecommunication device 20ₖ has to report as a channel state information.

The downlink linear transform matrix V_{DL}^{T} is also defined, as it will be disclosed hereinafter, so that the first telecommunication device 20ₖ has good channel conditions at the output x′(p).

The downlink linear transform module 310 executes a linear transform on the signals received by the first telecommunication device. The downlink linear transform module 310 executes a linear transform on the m₀ pilot signals transferred by the first telecommunication device 20ₖ to the second telecommunication device 10 which comprise then a channel state information.

Preferably and in a non limitative way, the channel interface 205 comprises an uplink direction control module 315 which controls the spatial direction of the signals transferred to the second telecommunication device 10 by Mₖ times duplicating the signals and weighting the duplicated signals by coefficients in order to perform beamforming, i.e. controls the spatial direction of the transmitted signals.

FIG. 3b is a diagram representing the architecture of a channel interface according to a second mode of realisation of the first telecommunication device.

According to the second mode of realisation of the first telecommunication device, the channel interface 205 comprises a MIMO channel matrix estimation module 320.

The MIMO channel matrix estimation module 320 estimates also the matrix H_{UL,k} which is the N*Mₖ uplink MIMO channel matrix between the first telecommunication device 20ₖ and the second telecommunication device 10.

Each element (n,m) with m=1 to Mₖ and n=1 to N of the matrix H_{UL,k} represents the complex propagation gain from the m-th antenna of the first telecommunication device 20ₖ and the n-th of the second telecommunication device 10.

Preferably the matrix H_{UL,k} is equal to H^{T}_{DL,k} where [.]^{T} denotes the transpose of [.].

The channel interface 205 comprises an uplink linear transform module 325 which comprises means for executing a linear transformation of m₀ signals r′(p)=[r′₁(p), . . . , r′ₘ₀(p)]^{T} into the Mₖ×1 signal vector r(p) using the Mₖ×m₀ linear transformation matrix V_{UL} as r(p)=V_{UL}r(p)′.

The dimension of the uplink linear transform matrix V_{UL} is defined according to the number of information representative of the quality of the signals transferred between the first and second telecommunication devices that the first telecommunication device 20ₖ has to report as a channel state information

As it will be disclosed hereinafter, the uplink linear transform matrix V_{UL} is also defined so that good channel conditions are maintained between the first telecommunication device 20ₖ and the second telecommunication device 10.

The uplink linear transform module 325 executes a linear transform on the signals representative of groups of data transferred by the first telecommunication device. The uplink linear transform module 305 executes a linear transform on the m₀ pilot signals transferred by the first telecommunication device 20ₖ to the second telecommunication device 10 which comprise then a channel state information.

Preferably and in a non limitative way, the channel interface 205 comprises an uplink direction control module 335 which controls the spatial direction of the signals transferred to the second telecommunication device 10 by Mₖ times duplicating the signals and weighting the duplicated signals by coefficients in order to perform beamforming, i.e. controls the spatial direction of the transmitted signals.

FIG. 3c is a diagram representing the architecture of a channel interface according to a third mode of realisation of the first telecommunication device.

According to the third mode of realisation of the first telecommunication device, the channel interface 205 comprises a channel estimation module 340.

The second telecommunication device 10 transfers N pilot signals s(p)=[s₁(p), . . . , s_{N}(p)]^{T} using fixed N transmit beamforming based on the constant N*1 different weights w₁, . . . , w_{N}. The first telecommunication device 20ₖ receives a Mₖ*1 signal vector xₖ(p)=H_{DL,k}Ws(p)+zₖ(p) with W=[w₁, . . . , w_{N}].

The channel interface 205 comprises an downlink direction control module 345 which controls the spatial direction of the signals received from the second telecommunication device 10.

The downlink direction control module 345 performs a downlink beamforming for each signal s₁(p), . . . , s_{N}(p).

The downlink direction control module 345 uses N weights vₖₙ with n=1 to N in order to perform the downlink beamforming.

Preferably, the weight vₖₙ for the n-th signal is given by a Minimum Mean

$$Squared Error ( MMSE ) weight {v}_{kn} = {Φ}^{- 1} {a}_{n}$$

$$where Φ = \frac{1}{{p}_{0}} {\sum }_{p = 1}^{{p}_{0}} {x}_{k} ( p ) {{x}_{k} ( p )}^{H} , {a}_{n} = \frac{1}{{p}_{0}} {\sum }_{p = 1}^{{p}_{0}} {x}_{k} ( p ) {{s}_{n} ( p )}^{*} ,$$

p₀ is the number of symbols of each pilot signal, [ ]^{H} denotes the complex conjugate transpose and [ ]* denotes the complex conjugate.

From the output of the downlink direction control module 345, the channel estimation module 340 measures the downlink channel quality for each signal s₁(p), . . . , s_{N}(p). Preferably and in a non limitative way, the downlink channel quality is the Signal to Interference plus Noise Ratio γ₁ to γ_{N} determined respectively for each signal s₁(p) to s_{N}(p).

Preferably and in a non limitative way, the channel interface 205 comprises an uplink direction control module 350 which controls the spatial direction of the signals transferred to the second telecommunication device 10 by Mₖ times duplicating the signals and weighting the duplicated signals by coefficients in order to perform beamforming, i.e. controls the spatial direction of the transmitted signals.

FIG. 4 is a diagram representing the architecture of the second telecommunication device according to the present invention.

The second telecommunication device 10, has, for example, an architecture based on components connected together by a bus 401 and a processor 400 controlled by programs related to the algorithm as disclosed in the FIGS. 5 to 8.

It has to be noted here that the second telecommunication device 10 is, in a variant, implemented under the form of one or several dedicated integrated circuits which execute the same operations as the one executed by the processor 400 as disclosed hereinafter.

The bus 401 links the processor 400 to a read only memory ROM 402, a random access memory RAM 403 and a channel interface 405.

The read only memory ROM 402 contains instructions of the programs related to the algorithm as disclosed in the FIGS. 5 to 8 which are transferred, when the second telecommunication 10 is powered onto the random access memory RAM 403.

The RAM memory 403 contains registers intended to receive variables, and the instructions of the programs related to the algorithm as disclosed in the FIGS. 5 to 8.

According to the present invention, the processor 400 determines, for each first telecommunication device 20ₖ, the number of information representative of the quality of the signals transferred between the first and second telecommunication devices each first telecommunication device 20ₖ has to report as a channel state information

According to the present invention, the processor 400 is able to determine, for each first telecommunication device 20₁ to 20_{K}, from the channel state information transferred by each first telecommunication device 20₁ to 20_{K}, the modulation and coding scheme to be used by each first telecommunication device 20ₖ for receiving groups of data. The processor 400 is able to determine to which first telecommunication device 20, signals representative of a group of data have to be sent according to the channel state information transferred by the first telecommunication devices 20. The processor 400 determines for each first telecommunication device 20₁ to 20_{K}, from the channel state information transferred by each first telecommunication device 20ₖ, the modulation and coding scheme to be used by each first telecommunication device 20ₖ for transferring groups of data or pilot signals and/or determines which first telecommunication device 20 has to transfer signals representative of a group of data to the second telecommunication devices 10.

Preferably and in a non limitative way, the channel interface 405 comprises a downlink direction control module, not shown in the FIG. 4, which controls the spatial direction of the signals transferred to each first telecommunication devices 20₁ to 20_{K} by N times duplicating the signals and weighting the duplicated signals by coefficients in order to perform beamforming, i.e. controls the spatial direction of the transmitted signals.

FIG. 5 is an algorithm executed by the second telecommunication device according to a first mode of realisation of the second telecommunication device.

The present algorithm is executed each time a new first telecommunication device 20 is detected by the second telecommunication device 10 and/or periodically.

At step S500, the processor 400 of the second telecommunication device 10 receives from each first telecommunication device 20₁ to 20_{K}, through the uplink channel, information representative of the number of antennas each first telecommunication device 20₁ to 20_{K} has. At the same step, the processor 400 determines the number K of first telecommunication devices 20.

The processor 400 memorises the number of antennas M₁ to M_{K} and K in the RAM memory 403.

At next step S501, the processor 400 initializes the value of the variables m₀(1) to m₀(K) to one.

At next step S502, the processor 400 selects a variable k′ with 1≦k′≦K. Preferably, the processor 400 selects randomly k′.

At next step S503, the processor 400 checks whether or not the sum of the variables m₀(1) to m₀(K) is lower than the total number C of available pilot signals, the second telecommunication device 10 can use.

It has to be noted here that K≦C.

If the sum of the variables m₀(1) to m₀(K) is equal to the total number C of available pilot signals, the processor 400 moves to step S525.

If the sum of the variables m₀(1) to m₀(K) is lower than the total number C of available pilot signals, the processor 400 moves to step S504.

At step S504, the processor 400 sets the variable k to the value of the variable k′.

At next step S505, the processor 400 checks if the variable m₀(k) is equal to the number of antennas M_{K} of the first telecommunication device 20ₖ.

If the variable m₀(k) is equal to the number of antennas M_{K} of the first telecommunication device 20ₖ, the processor 400 moves to step S507.

If the variable m₀(k) is not equal to the number of antennas M_{K} of the first telecommunication device 20ₖ, the processor 400 moves to step S506.

At step S506, the processor 400 increments the value of variable m₀(k), as example of one and moves to step S507.

At next step S507, the processor 400 checks whether or not the sum of the variables m₀(1) to m₀(K) is lower than the total number C of available pilot signals, the second telecommunication device 10 has.

If the sum of the variables m₀(1) to m₀(K) is equal to the total number C of available pilot signals, the processor 400 moves to step S525.

If the sum of the variables m₀(1) to m₀(K) is lower than the total number C of available pilot signals, the processor 400 moves to step S508.

At step S508, the processor 400 checks if the value of k is equal to K.

If the value of k is not equal to K, the processor 400 moves to step S509, increments the value of variable k by one and returns to step S505.

If the value of k is equal to K, the processor 400 moves to step S515.

At step S515, the processor 400 set the value of the variable k to one.

At next step S515, the processor 400 checks if the variable m₀(k) is equal to the number of antennas M_{K} of the first telecommunication device 20ₖ.

If the variable m₀(k) is equal to the number of antennas M_{K} of the first telecommunication device 20ₖ, the processor 400 moves to step S518.

If the variable m₀(k) is not equal to the number of antennas M_{K} of the first telecommunication device 20ₖ, the processor 400 moves to step S517.

At step S517, the processor 400 increments the value of variable m₀(k), as example of one and moves to step S518.

At next step S518, the processor 400 checks whether or not the sum of the variables m₀(1) to m₀(K) is lower than the total number C of available pilot signals, the second telecommunication device 10 has.

If the sum of the variables m₀(1) to m₀(K) is equal to the total number C of available pilot signals, the processor 400 moves to step S525.

If the sum of the variables m₀(1) to m₀(K) is lower than the total number C of available pilot signals, the processor 400 moves to step S519.

At step S519, the processor 400 checks if the value of k is equal to k′−1.

If the value of k is not equal to k′−1, the processor 400 moves to step S520, increments the value of variable k by one and returns to step S516.

If the value of k is equal to k′−1, the processor 400 returns to step S502.

At step S525, the processor 400 commands the transfer to each first telecommunication device 20ₖ with k×1 to K of the corresponding value of the variable m₀(k).

For each first telecommunication device 20ₖ, the variable m₀(k) is the number of information representative of the quality of the signals transferred between the first and second telecommunication devices that the first telecommunication device 20ₖ has to report as a channel state information.

At next step S526, the processor 400 of the second telecommunication device 10 commands the transfer of pilot signals to at least a part of the first telecommunication devices 20ₖ, with k=1 to K.

The processor 400 allocates then to each at least a part of the first telecommunication device 20ₖ, a number of pilot signals which is equal to m₀(k).

At next step S527, the processor 400 detects the reception of the channel state information transferred by at least a part of the first telecommunication devices 20.

The channel state information is received under the form of pilot signals or under the form of bit information.

At next step S528, the processor 400 determines to which first telecommunication device 20ₖ, with k=1 to K, group of data has to be transferred according to the channel state information received from at least the part of the first telecommunication devices 20. The processor 400 determines also the modulation and coding scheme to be used by each first telecommunication device 20ₖ for receiving groups of data or for transferring groups of data.

FIG. 6 is an algorithm executed by the second telecommunication device according to a second mode of realisation of the second telecommunication device.

The present algorithm is executed each time a new first telecommunication device 20 is detected by the second telecommunication device 10 and/or periodically.

At step S600, the processor 400 of the second telecommunication device 10 receives from each first telecommunication device 20₁ to 20_{K}, through the uplink channel, information representative of the number of antennas each first telecommunication device 20₁ to 20_{K} has and their respective requirement DR(k) in term of data rate. At the same step, the processor 400 determines the number K of first telecommunication devices 20.

The processor 400 memorises the number of antennas M₁ to M_{K}, the requirements DR(1) to DR(K) in term of data rate and K in the RAM memory 403.

At next step S601, the processor 400 initializes the value of the variables m₀(1) to m₀(K) to one.

At next step S602, the processor 400 forms a list which comprises the variables m₀(k) which are lower than the corresponding Mₖ.

At next step S603, the processor 400 checks if the formed list is empty or not.

If the list is empty, the processor 400 moves to step S607.

If the list is not empty, the processor 400 moves to step S604.

At step S604, the processor 400 selects in the list, the variable m₀(k) which corresponds to the largest value of DR(k)/m₀(k).

At next step S605, the processor 400 increments the value of the selected variable m₀(k), as example of one and moves to step S606.

At next step S606, the processor 400 checks whether or not the sum of the variables m₀(1) to m₀(K) is lower than the total number C of available pilot signals, the second telecommunication device 10 can use, where K≦C.

If the sum of the variables m₀(1) to m₀(K) is equal to the total number C of available pilot signals, the processor 400 moves to step S607.

If the sum of the variables m₀(1) to m₀(K) is lower than the total number C of available pilot signals, the processor 400 moves to step S602.

At step S607, the processor 400 commands the transfer to each first telecommunication device 20ₖ with k=1 to K of the corresponding value of the variable m₀(k).

For each first telecommunication device 20ₖ, the variable m₀(k) is the number of information representative of the quality of the signals transferred between the first and second telecommunication devices that the first telecommunication device 20ₖ has to report as a channel state information.

At next step S608, the processor 400 of the second telecommunication device 10 commands the transfer of pilot signals to at least a part of the first telecommunication device 20ₖ, with k=1 to K.

The processor 400 allocates then to each at least a part of the first telecommunication device 20ₖ, a number of pilot signals which is equal to m₀(k).

At next step S609, the processor 400 detects the reception of the channel state information transferred by at least a part of the first telecommunication devices 20.

The channel state information is received under the form of pilot signals or under the form of bit information comprised in a group of data.

At next step S610, the processor 400 determines to which first telecommunication device 20ₖ, with k=1 to K, group of data has to be transferred according to the channel state information received from at least the part of the first telecommunication devices 20.

The processor 400 determines also the modulation and coding scheme to be used by each first telecommunication device 20ₖ for receiving groups of data or for transferring groups of data.

FIG. 7 is an algorithm executed by the second telecommunication device according to a third mode of realisation of the second telecommunication device.

The present algorithm is executed each time a new first telecommunication device 20 is detected by the second telecommunication device 10 and/or periodically.

At step S700, the processor 400 of the second telecommunication device 10 receives from each first telecommunication device 20₁ to 20_{K}, through the uplink channel, information representative of the number of antennas each first telecommunication device 20₁ to 20_{K} has and their respective requirement DT(k) in term of response delay. At the same step, the processor 400 determines the number K of first telecommunication devices 20.

The processor 400 memorises the number of antennas M₁ to M_{K}, the requirements DT(1) to DT(K) in term of response delay and K in the RAM memory 403.

At next step S701, the processor 400 initializes the value of the variables m₀(1) to m₀(K) to one.

At next step S702, the processor 400 forms a list which comprises the variables m₀(k) which are lower than the corresponding Mₖ.

At next step S703, the processor 400 checks if the formed list is empty or not.

If the list is empty, the processor 400 moves to step S707.

If the list is not empty, the processor 400 moves to step S704.

At step S704, the processor 400 selects in the list, the variable m₀(k) which corresponds to the smallest value of DT(k)*m₀(k).

At next step S705, the processor 400 increments the value of the selected variable m₀(k), as example of one and moves to step S706.

At next step S706, the processor 400 checks whether or not the sum of the variables m₀(1) to m₀(K) is lower than the total number C of available pilot signals, the second telecommunication device 10 can use, where K≦C.

If the sun of the variables m₀(1) to m₀(K) is equal to the total number C of available pilot signals, the processor 400 moves to step S707.

If the sum of the variables m₀(1) to m₀(K) is lower than the total number C of available pilot signals, the processor 400 moves to step S702.

At step S707, the processor 400 commands the transfer to each first telecommunication device 20ₖ with kill to K of the corresponding value of the variable m₀(k).

For each first telecommunication device 20ₖ, the variable m₀(k) is the number of information representative of the quality of the signals transferred between the first and second telecommunication devices that the first telecommunication device 20ₖ has to report as a channel state information.

At next step S708, the processor 400 of the second telecommunication device 10 commands the transfer of pilot signals to at least a part of the first telecommunication device 20ₖ, with k=1 to K.

The processor 400 allocates then to each at least a part of the first telecommunication device 20ₖ, a number of pilot signals which is equal to m₀(k).

At next step S709, the processor 400 detects the reception of the channel state information transferred by at least a part of the first telecommunication devices 20.

The channel state information is received under the form of pilot signals or under the form of bit information comprised in a group of data.

At next step S710, the processor 400 determines to which first telecommunication device 20ₖ, with k=1 to K, group of data has to be transferred according to the channel state information received from at least the part of the first telecommunication devices 20.

The processor 400 determines also the modulation and coding scheme to be used by each first telecommunication device 20ₖ for receiving groups of data or for transferring groups of data.

FIG. 8 is an algorithm executed by the second telecommunication device according to a fourth mode of realisation of the second telecommunication device.

The present algorithm is executed each time a new first telecommunication device 20 is detected by the second telecommunication device 10 and/or periodically.

At step S800, the processor 400 of the second telecommunication device 10 receives from each first telecommunication device 20₁ to 20_{K}, through the uplink channel, information representative of the number of antennas each first telecommunication device 20₁ to 20_{K} has. At the same step, the processor 400 determines the number K of first telecommunication devices 20.

The processor 400 memorises the number of antennas M₁ to M_{K} and K in the RAM memory 403.

At next step S801, the processor 400 initializes the value of the variables m₀(1) to m₀(K) to one.

At next step S802, the processor 400 forms a list which comprises the variables m₀(k) which are lower than the corresponding Mₖ.

At next step S803, the processor 400 checks if the formed list is empty or not.

If the list is empty, the processor 400 moves to step S807.

If the list is not empty, the processor 400 moves to step S804.

At step S804, the processor 400 selects in the list, the variable m₀(k) which corresponds to the largest value of Mₖ/m₀(k).

At next step S805, the processor 400 increments the value of the selected variable m₀(k), as example of one and moves to step S806.

At next step S806, the processor 400 checks whether or not the sum of the variables m₀(1) to m₀(K) is lower than the total number C of available pilot signals, the second telecommunication device 10 can use, where K≦C.

If the sum of the variables m₀(1) to m₀(K) is equal to the total number C of available pilot signals, the processor 400 moves to step S807.

If the sum of the variables m₀(1) to m₀(K) is lower than the total number C of available pilot signals, the processor 400 moves to step S802.

At step S807, the processor 400 commands the transfer to each first telecommunication device 20ₖ with k=1 to K of the corresponding value of the variable m₀(k).

For each first telecommunication device 20ₖ, the variable m₀(k) is the number of information representative of the quality of the signals transferred between the first and second telecommunication devices that the first telecommunication device 20ₖ has to report as a channel state information.

At next step S808, the processor 400 of the second telecommunication device 10 commands the transfer of pilot signals to at least a part of the first telecommunication device 20ₖ, with k=1 to K.

The processor 400 allocates then to each at least a part of the first telecommunication device 20ₖ, a number of pilot signals which is equal to m₀(k).

At next step S809, the processor 400 detects the reception of the channel state information transferred by at least a part of the first telecommunication devices 20.

The channel state information is received under the form of pilot signals or under the form of bit information comprised in a group of data.

At next step S810, the processor 400 determines to which first telecommunication device 20ₖ, with k=1 to K, group of data has to be transferred according to the channel state information received from at least the part of the first telecommunication devices 20.

The processor 400 determines also the modulation and coding scheme to be used by each first telecommunication device 20ₖ for receiving groups of data or for transferring groups of data.

Is has to be noted here that the first, second, third and fourth modes of realisation of the second telecommunication device are in a variant combined in order to determine m₀(k) according to the number of first telecommunication devices 20 and/or the number of antennas the first telecommunication devices 20 have and/or according to the requirements in term of data rate and or response delay.

By changing for each first telecommunication device, the number of information representative of the quality of the signals transferred between the first and second telecommunication devices the first telecommunication device has to report as a channel state information according to the number of first telecommunication devices 20 and/or the number of antennas the first telecommunication devices 20 have and/or according to the requirements in term of data rate and or response delay for the channel station information reporting, the available resources of the wireless telecommunication network are efficiently used in any environment.

FIG. 9 is an algorithm executed by the first telecommunication device according to the first mode of realisation of the first telecommunication device.

The present algorithm is executed by each first telecommunication device 20₁ to 20_{K}, it will be disclosed when it is executed by the first telecommunication device 20ₖ.

At step S900, the processor 200 of, as example, the first telecommunication device 20ₖ, detects the reception through the channel interface 205 of a group of data which comprises the variable m₀(k) which is the number of information representative of the quality of the signals transferred between the first and second telecommunication devices that the first telecommunication device 20ₖ has to report as a channel state information.

The variable m₀(k) is either determined according to the first or second or third or fourth modes of realisation of the second telecommunication device.

At step S901, the first telecommunication device 20k receives pilot signals xₖ(p)=H_{DL,k}s(p)+zₖ(p) through the channel interface 205.

At next step S902, the MEMO channel matrix estimation module 305 estimates the matrix H_{DL,k} from the received pilot signals.

At next step S903, the processor 200 of the first telecommunication device 20ₖ performs a singular value decomposition of H_{DL,k}^{T}=UΛQ^{H},

where U=[u₁, . . . , u_{N}] is the N*N unitary matrix, Q=└q₁, . . . , q_{M}_{ₖ}┘ is the Mₖ*Mₖ unitary matrix, [ ]^{H} denotes the complex conjugate transpose and Λ=diag[λ₁, λ₂, . . . , λ_{d}] with λ₁≧ . . . ≧λ_{d}≧0 is the N*Mₖ diagonal matrix of singular values with d=min{Mₖ,N}.

At next step S904, the processor 200 selects the m₀(k) largest singular-values. As example, if the first telecommunication device 20k has three antennas, and the received m₀(k) equals to two, only the two largest singular-values are selected.

It has to be noted here that, the m₀(k) singular-values are selected from the downlink MIMO channel matrix H_{DL,k} between the second telecommunication device 10 and the first telecommunication device 20ₖ.

At next step S905 the processor 200 determines a downlink linear transform matrix V_{DL}.

The first telecommunication device 20ₖ determines V_{DL} as V_{DL}=└q₁, . . . , qₘ₀₍ₖ₎┘, where └q₁, . . . , qₘ₀₍ₖ₎┘ are the vectors which correspond to the selected singular-values.

The virtual downlink MIMO channel \tilde{H}_{DL,k}=V_{DL}^{T}H_{DL,k} is then expressed as \tilde{H}_{DL,k}=V_{DL}^{T}H_{DL,k}=(H_{DL,k}^{T}V_{DL})^{T}=[λ₁u₁, . . . , λₘ₀₍ₖ₎uₘ₀₍ₖ₎]^{T}.

In a different form, H_{DL,k}^{T}=UΛQ^{H} can then be transformed into H_{DL,k}*H_{DL,k}^{T}=QΛ²Q^{H}, where [ ]* denotes the complex conjugate. Here we have:
H_{DL,k}*H_{DL,k}^{T}Q=QΛ²
H_{DL,k}*H_{DL,k}^{T}qₘ=λₘ²qₘ.

As q₁, . . . , qₘ₀₍ₖ₎ are the selected eigenvectors of H_{DL,k}*H_{DL,k}^{T}, V_{DL} is given by:

V_{DL}=└[e₁ [symbol] H_{DL,k}*H_{DL,k}^{T} [symbol] , . . . , eₘ₀₍ₖ₎<H_{DL,k}*H_{DL,k}^{T}>┘, where eₘ [symbol] .> denotes the eigenvector of [symbol] [symbol] corresponding to the m-th largest eigenvalue.

It has to be noted here that, if the telecommunication system uses Time Division Duplexing scheme, H_{DL,k}^{T}=H_{DL,k}, the first telecommunication device 20ₖ sends m₀(k) pilot signals r′(p) multiplied by the uplink linear transform matrix V_{DL}.

As the received signal at the second telecommunication device 10 is represented by x_{BS}(p)=H_{UL,k}V_{DL}r′(p)+z_{BS}(p), the second telecommunication device 10 can obtain (H_{UL,k}V_{DL})^{T}=V_{DL}^{T}H_{UL,k} from x_{BS}(p), where H_{UL,k} is the N*Mₖ uplink MIMO channel matrix between the first telecommunication device 20ₖ and the second telecommunication device 10.

Each element (n,m) with m=1 to Mₖ and n=1 to N of the matrix H_{UL,k} represents the complex propagation gain from the m-th antenna of the first telecommunication device 20ₖ and the n-th of the second telecommunication device 10.

At the same step, the processor 200 transfers the determined matrix V_{DL} to the downlink linear transform module 310 which uses the determined matrix V_{DL} for executing a linear transformation of the signal vector xₖ(p) using the m₀(k)*Mₖ matrix V_{DL}^{T}.

At next step S906, the processor 200 determines the channel state information on the downlink channel considering x′(p).

According to a particular feature of the present invention, the channel state information is the m₀(k)*N virtual downlink MIMO channel matrix \tilde{H}_{DL,k}.

At next step S907, the processor 200 commands the transfer, to the second telecommunication device 10, of the determined channel state information through the uplink channel.

Preferably, the channel state information is reported by transferring m₀(k) pilot signals which are multiplied by the downlink linear transform matrix V_{DL}. As the signals transferred by the first telecommunication device are also multiplied by the propagation gains between the antennas of the telecommunication devices, the channel responses at the second telecommunication device 10 is given by H_{UL,k}V_{DL}=(V_{DL}^{T}H_{UL,k})^{T}.

Therefore, the second telecommunication device 10 obtains the knowledge of the virtual downlink MEMO channel \tilde{H}_{DL,k}=V_{DL}^{T}H_{DL,k} from the m₀(k) received pilot signals.

It has to be noted here that, the channel state information can also be reported under the form of information bits.

The processor 200 returns then to step S900.

FIG. 10 is an algorithm executed by the first telecommunication device according to the second mode of realisation of the first telecommunication device.

The present algorithm is executed by each first telecommunication device 20, to 20_{K}, it will be disclosed when it is executed by the first telecommunication device 20ₖ.

At step S100, the processor 200 of, as example, the first telecommunication device 20ₖ, detects the reception through the channel interface 205 of a group of data which comprises the variable m₀(k) which is the number of information representative of the quality of the signals transferred between the first and second telecommunication devices that the first telecommunication device 20ₖ has to report as a channel state information.

The variable m₀(k) is either determined according to the first or second or third or fourth modes of realisation of the second telecommunication device.

At step S101, the first telecommunication device 20k receives pilot signals xₖ(p)=H_{DL,k}s(p)+zₖ(p) through the channel interface 205.

At next step S102, the MIMO channel matrix estimation module 320 estimates the uplink channel matrix H_{UL,k}.

In TDD scheme, H_{UL,k}=H_{DL,k}^{T} as the channel responses between the uplink and downlink channels of the telecommunication network 15 are reciprocal.

In FDD scheme, the channel responses between the uplink and downlink channels of the telecommunication network 15 are not perfectly reciprocal. However, since the uplink and the downlink channels have similar characteristics, especially for channels having a large gain, H_{UL,k}=H_{DL,k}^{T} can be considered also.

At next step S103, the processor 200 of the first telecommunication device 20ₖ performs a singular value decomposition of H_{UL,k}=U_{U}Λ_{U}Q_{U}^{H} where U_{U}=[U_{U1}, . . . , U_{UN}] is the N*N unitary matrix, Q_{U}=[q_{U1}, . . . , q_{UMk}] is the Mₖ*Mₖ unitary matrix and Λ_{U}=diag[λ_{U1}, λ_{U2}, . . . , λ_{Ud}] with λ_{U1}≧ . . . ≧λ_{Ud}≧0 is the N*Mₖ diagonal matrix of real singular-values with d=min {Mₖ, N}.

At next step S104, the processor 200 selects the m₀(k) largest singular-values.

It has to be noted also that, the m₀(k) singular-values are selected from the uplink MIMO channel matrix H_{UL,k} between the first telecommunication device 20ₖ and the second telecommunication device 10.

At next step S105 the processor 200 determines a linear transform matrix V_{UL}.

The first telecommunication device 20ₖ determines V_{UL} as V_{UL}=└q_{U1}, . . . , q_{Um0(k)}┘.

The virtual uplink MIMO channel \tilde{H}_{UL,k}=H_{UL,k}V_{UL} is then expressed as \tilde{H}_{UL,k}=h_{UL,k}V_{UL}=[λ_{U1}u_{U1}, . . . , λ_{Um0(k)}u_{Um0(k)}]^{T}.

On the same way as the one disclosed for V_{DL}, V_{UL} is given by:

V_{UL}=└e₁<H_{UL,k}^{H}H_{UL,k} [symbol] . . . eₘ₀₍ₖ₎<H_{UL,k}^{H}H_{UL,k} [symbol] , where eₘ [symbol] . [symbol] denotes the eigenvector of [symbol] [symbol] corresponding to the m-th largest eigenvalue.

At next step S105, the processor 200 transfers the determined matrix V_{UL} to the uplink linear transform module 325 which uses the determined matrix V_{UL} for executing a linear transformation of the m₀(k) signals r′(p)=[r′₁(p), . . . , r′ₘ₀₍ₖ₎(p)]^{T} into the signal vector r(p) using the linear transformation matrix V_{UL} as r(p)=V_{UL}r(p)′.

At next step SI 07, the processor 200 commands the transfer, to the second telecommunication device 10, of the determined channel state information through the uplink channel.

Preferably, the channel state information is reported by transferring m₀(k) pilot signals composed of p₀ symbols r′(1), . . . r′(p₀) to the second telecommunication device 10 through the channel interface 205.

The processor 200 returns then to step S100.

FIG. 11 is an algorithm executed by the first telecommunication device according to the third mode of realisation of the first telecommunication device.

The present algorithm is executed by each first telecommunication device 20₁ to 20_{K}, it will be disclosed when it is executed by the first telecommunication device 20ₖ.

At step S110, the processor 200 of, as example, the first telecommunication device 20ₖ, detects the reception through the channel interface 205 of a group of data which comprises the variable m₀(k) is the number of information representative of the quality of the signals transferred between the first and second telecommunication devices that the first telecommunication device 20ₖ has to report as a channel state information.

The variable m₀(k) is either determined according to the first or second or third or fourth modes of realisation of the second telecommunication device.

At step S111, the first telecommunication device 20k receives pilot signals through the channel interface 205.

The second telecommunication device 10 transfers N pilot signals s(p)=[s₁(p), . . . , s_{N}(p)]^{T} using fixed N transmit beamforming based on the constant N*1 different weights w₁, . . . , w_{N}.

The first telecommunication device 20ₖ receives a Mₖ*1 signal vector xₖ(p)=H_{DL,k}Ws(p)+zₖ(p) with W [w₁, . . . , w_{N}].

The downlink direction control module 345 performs a downlink beamforming for each signal s₁(p), . . . , s_{N}(p).

The downlink direction control module 345 uses N weights vₖₙ with n=1 to N in order to perform the downlink beamforming.

Preferably, the weight vₖₙ for the n-th signal is given by

$${v}_{kn} = {Φ}^{- 1} {a}_{n}$$

$$where Φ = \frac{1}{{p}_{0}} {\sum }_{p = 1}^{{p}_{0}} {x}_{k} ( p ) {{x}_{k} ( p )}^{H} , {a}_{n} = \frac{1}{{p}_{0}} {\sum }_{p = 1}^{{p}_{0}} {x}_{k} ( p ) {{s}_{n} ( p )}^{*} .$$

At next step S112, the processor 200 commands the channel estimation module 340 of the channel interface 205 to transfer a downlink channel quality estimated for each signal s₁(p), . . . , s_{N}(p).

From the output of the downlink direction control module 345, the channel estimation module 340 measures the downlink channel quality for each signal s₁(p), . . . , s_{N}(p). Preferably and in a non limitative way, the downlink channel quality is the Signal to Interference plus Noise Ratio γ₁ to γ_{N} determined at the outputs vₖ₁^{T}xₖ(p), . . . , v_{kN}^{T}xₖ(p) respectively for each signal s₁(p) to s_{N}(p).

At next step S113, the processor 200 selects the m₀(k) largest Signal to Interference plus Noise Ratio among the N Signal to Interference plus Noise Ratio γ₁ at γ_{N}.

At next step S114, the processor 200 commands the transfer, to the second telecommunication device 10, of the selected m₀(k) largest Signal to Interference plus Noise Ratio as a channel state information through the uplink channel.

FIG. 12 is an example of the channel state information transferred by a first telecommunication device according to the third mode of realisation of the first telecommunication device.

The channel state information is composed of the m₀(k), in the present example m₀(k)=3, largest Signal to Interference plus Noise Ratio represented by CQI(1) to CQI(3) and the identifier n₁ to n₃ of the beamformers which correspond to the selected largest Signal to Interference plus Noise Ratio.

The channel state information is transferred in a group of data.

Many other techniques can be used also in the present invention.

As example, the first telecommunication device 20ₖ determines the propagation gains between the antennas of the first and second telecommunication devices as it has already been described.

The first telecommunication device 20ₖ forms a downlink channel matrix

$${H}_{DL , k} = [ \begin{matrix}{h}_{1} \\ ⋮ \\ ⋮ \\ {h}_{Mk}\end{matrix} ] ,$$

where hₘ with m=1 to Mₖ is a 1*N vector.

The first telecommunication device 20ₖ forms, for each of the first telecommunication device's antenna, a group propagation gains and determines among the groups, the ones which have the highest norm.

The first telecommunication device selects among the determined propagation gains the group or groups which has or have the highest m₀(k) norm, as the subset of the determined propagation gains.

The first telecommunication device 20ₖ selects m₀(k) antennas among its Mₖ antennas which have the m₀(k) largest values ∥hₘ∥ among ∥h₁∥, . . . , ∥h_{Mk}∥.

For instance, the first telecommunication device 20 has 4 antennas, m₀(k)=2 and ∥h₁∥ and ∥h₃∥ are higher than ∥h₂∥ and ∥h₄∥.

The downlink linear transform matrix V_{DL} is then equal to:

$${V}_{DL} = [ \begin{matrix}1 & 0 \\ 0 & 0 \\ 0 & 1 \\ 0 & 0\end{matrix} ] . \\ Then , {V}_{DL}^{T} {H}_{DL , k} = [ \begin{matrix}{h}_{1} \\ {h}_{3}\end{matrix} ] .$$

Thus, the virtual MIMO downlink channel comprises only the highest propagation gains ∥h₁∥ and ∥h₃∥.

Naturally, many modifications can be made to the embodiments of the invention described above without departing from the scope of the present invention.

1. Method for controlling channel state information transferred by a first telecommunication device to a second telecommunication device, the first telecommunication device determining information representative of the quality of the signals transferred between the first and second telecommunication devices, characterised in that the method comprises the steps executed by the second telecommunication device of:
determining a number of information representative of the quality of the signals transferred between the first and second telecommunication devices the first telecommunication device has to report as a channel state information,
transferring the determined number to the first telecommunication device.

2. Method according to claim 1, characterised in that the number of information representative of the quality of the signals transferred between the first and second telecommunication devices the first telecommunication device has to report is lower than the number of the determined information representative of the quality of the signals transferred between the first and second telecommunication devices.

3. Method according to claim 2, characterised in that the method comprises further step of allocating to the first telecommunication device a number of pilot signals which is equal to the determined number.

4. Method according to any of the claims 1 to 3, characterised in that the method comprises further step of:
receiving the channel state information from the first telecommunication device,
controlling the transfer of the signals representative of at least a group of data between the first and the second telecommunication devices according to received the channel state information.

5. Method according to claim 3 or 4, characterised in that the method comprises further step of determining the number of first telecommunication devices which are linked to the second telecommunication device.

6. Method according to claim 5, characterised in that the number of information representative of the quality of the signals transferred between the first and second telecommunication devices the first telecommunication device has to report as a channel state information is determined according to the number of first telecommunication devices which are linked to the second telecommunication device.

7. Method according to claim 5 or 6, characterised in that the method comprises further step of receiving the number of antennas each first telecommunication device comprises and in that the number of information representative of the quality of the signals transferred between the first and second telecommunication devices each first telecommunication device has to report as a channel state information is determined according to the number of antennas the first telecommunication device comprises.

8. Method according to claim 5, characterised in that the method comprises further step of receiving from each first telecommunication device their respective requirement in term of data rate and in that the number of information representative of the quality of the signals transferred between the first and second telecommunication devices each first telecommunication device has to report as a channel state information is determined according to the requirements in term of data rate.

9. Method according to claim 5, characterised in that the method comprises further step of receiving from each first telecommunication device their respective requirement in term of response delay and in that the number of information representative of the quality of the signals transferred between the first and second telecommunication devices each first telecommunication device has to report as a channel state information is determined according to the requirements in term of response delay.

10. Method for transferring, by a first telecommunication device, channel state information to a second telecommunication device, the first telecommunication device determining information representative of the quality of the signals transferred between the first and second telecommunication devices, characterised in that the method comprises the steps executed by the first telecommunication device of:
receiving from the second telecommunication device a number of information representative of the quality of the signals transferred between the first and second telecommunication devices the first telecommunication device has to report as a channel state information,
determining a channel state information which comprises the received number of information representative of the quality of the signals transferred between the first and second telecommunication devices,
transferring the channel state information to the second telecommunication device.

11. Method according to claim 10, characterised in that the first telecommunication device comprises antennas and the second telecommunication device which comprises antennas and in that the quality of the signals transferred between the first and second telecommunication devices is the propagation gain between one antenna of the first telecommunication devices and one antenna of the second telecommunication device.

12. Method according to claim 11, characterised in that the propagations gains arc coefficients of a downlink channel matrix and the determined information representative of the quality of the signals transferred between the first and second telecommunication devices comprised in the channel state information are determined by executing a singular value decomposition of the downlink channel matrix.

13. Method according to claim 12, characterised in that the propagations gains are coefficients of an uplink channel matrix and the determined information representative of the quality of the signals transferred between the first and second telecommunication devices comprised in the channel state information are determined by executing a singular value decomposition of the uplink channel matrix.

14. Method according to claim 10, characterised in that the first telecommunication device comprises antennas and in that the channel state information is representative of the Signal to Interference plus Noise Ratio measured on signals received by the antennas of the first telecommunication device.

15. Device for controlling channel state information transferred by a first telecommunication device to a second telecommunication device, the first telecommunication device determining information representative of the quality of the signals transferred between the first and second telecommunication devices, characterised in that the device for controlling is included in the second telecommunication device and comprises:
means for determining a number of information representative of the quality of the signals transferred between the first and second telecommunication devices the first telecommunication device has to report as a channel state information,
means for transferring the determined number to the first telecommunication device.

16. First telecommunication device which transfers channel state information to a second telecommunication device, the first telecommunication device determining information representative of the quality of the signals transferred between the first and second telecommunication devices, characterised in that the first telecommunication device comprises:
means for receiving from the second telecommunication device a number of information representative of the quality of the signals transferred between the first and second telecommunication devices the first telecommunication device has to report as a channel state information,
means for determining a channel state information which comprises the received number of information representative of the quality of the signals transferred between the first and second telecommunication devices,
means for transferring the channel state information to the second telecommunication device.

17. Computer program which can be directly loadable into a programmable device, comprising instructions or portions of code for implementing the steps of the method according to claims 1 to 9, when said computer program is executed on a programmable device.

18. Computer program which can be directly loadable into a programmable device, comprising instructions or portions of code for implementing the steps of tile method according to claims 10 to 14, when said computer program is executed on a programmable device.

19. Signal transferred to a second telecommunication device from a first telecommunication device, characterised in that the signal comprises a number of information representative of the quality of the signals transferred between the first and second telecommunication devices the first telecommunication device has to report as a channel state information to the second telecommunication device.
